(19) United States
(12) Patent Application Publication
(10) Pub. No.: US 2009/0260071 A1
(43) Pub. Date: Oct. 15, 2009

(54) SMART MODULE PROVISIONING OF LOCAL NETWORK DEVICES

(75) Inventors: Vladimir Sadovsky, Redmond, WA (US); Oren Rosenbloom, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/102,021

(22) Filed: Apr. 14, 2008

(51) Int. Cl. H04L 9/32; G06F 21/00

(52) U.S. Cl. 726/9

(57) ABSTRACT

A card-based mechanism can enable users to secure their network by limiting network access to devices to which a card is communicationally connected, the card having been previously provisioned by the user. A trusted computing device can be used to provision a card. Subsequently, the card can be communicationally connected to a card-provisionable device and can use the networking abilities of that device to authenticate itself to the trusted computing device. The card-provisionable device can then be granted access to the network. The card can also be used to provision the device with other information, such as device-specific settings. If necessary, either the card or the trusted computing device can revoke the network access rights of the card-provisionable device without affecting other devices on the network.

### BACKGROUND

The proliferation of individually-managed small networks, especially wireless networks, increases the need for a simple solution for provisioning devices, both to communicate with the network, and to otherwise better perform their intended functions. Traditionally, small networks, such as home networks or small-office networks, are not managed by professional network technicians and, consequently, may not possess the security of more professionally-managed networks. The lack of security can be further exacerbated by the use of wireless network technology, which can enable attacks on the network from physically insecure locations, such as from the street outside of a home or small office.

As small networks become more ubiquitous, a greater range of network-capable devices become available. Such devices can further increase the need for network security. For example, an increasing number of medical devices, including medical devices for personal use, are network-capable. Similarly, common household appliances, such as refrigerators, are likewise becoming network-capable. Each of these devices has the potential to cause material, economic or emotional harm should they become compromised through an unsecure network.

Traditional mechanisms of securing small networks include password-based technologies, such that devices seeking to access the network must be in possession of one or more passwords or passcodes, and access-control technologies, such that only predetermined, and pre-identified, devices are allowed access to the network. To aid unsophisticated users in setting up secure small networks, a variety of mechanisms for storing and transporting increasingly complex passcodes have been developed. For example, a user can generate a complex passcode, or even a variable passcode and, rather than remembering it, the user can have such a passcode stored on a removable storage media, which the user can then physically connect to each device that the user wishes to have network access, thereby enabling the device to copy the passcode from the removable storage media. In theory, such complex or variable passcodes should render the small network more secure than a simple passcode that the user can remember, but which can also be easily guessed or derived from common passcode-attack strategies.

Rather than relying on passcodes or access-control technologies, wide-area wireless networks, such as cellular-technology-based networks, utilize Subscriber Identity Modules (SIM) cards that comprise a unique identifier. In particular, a device is allowed to access the wide-area wireless network only if it has a SIM card that identifies an individual who has previously subscribed to the wide-area wireless network services being sought. For obvious reasons, however, users of such wide-area wireless networks are not allowed to create or modify SIM cards. Instead, such capability is retained by the very few large corporations offering wide-area wireless networks.

### SUMMARY

To provide individuals with the ability to secure and maintain networks, especially small wireless networks, such as a home or small-office network, a card-based provisioning model can be used whereby the card can comprise authentication mechanisms to add devices to the network and can further comprise information to provision devices in accordance with previously determined user preferences. In one embodiment, a trusted computing device connected to the network can be utilized to store, onto a card, authentication information. Subsequently, the card can be inserted into a host device that is to be provided access to the network. By utilizing the host device's networking abilities, the card can communicate with the trusted computing device and authenticate itself to the trusted computing device. Once authenticated, the card can provide information regarding the host device, which can enable the trusted computing device to modify network access criteria to allow the host device access to the network.

In another embodiment, the trusted computing device can enable the user to further provision a device, such as by setting options available on the device. Provisioning information can be provided by the user, or obtained or derived by the trusted computing device on the user's behalf, and can be stored on the same card as the authentication information. Additionally, or alternatively, the card can further comprise a virtual machine and provisioning instructions such that the card can, by itself, provision the device once it is communicationally coupled to the device. Thus, in addition to enabling its host device to access the network, the card can further provision its host device in accordance with the information stored on the card by the trusted computing device and provisioning instructions that can, optionally, also be stored on the card by the trusted computing device.

In a further embodiment, the card can withdraw its host device's access to the network, such as if the host device is stolen or improperly removed from the network. If the card detects that such an improper event has occurred, it can erase any authentication information stored thereon. Subsequent attempts to connect the host device to the network will, therefore, be unsuccessful, as the card will no longer authenticate itself or its host device to the trusted computing device.

In a still further embodiment, the trusted computing device can withdraw network access rights from any one or more network devices individually without requiring modification to any remaining device, such as would be required by a simple passcode change. For example, the trusted computing device can simply refuse to authenticate any future attempts from the particular card provided to the device whose network access is being revoked, thereby terminating the device's network access. The trusted computing device can likewise actively remove the revoked device from the list of devices to be granted network access, such as would be maintained by one or more network access points.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system that provides context for the described functionality;

FIG. 2 is a block diagram of an exemplary computing device;

FIG. 3 is a block diagram of an exemplary card-provisionable device;

FIG. 4 is a block diagram of an exemplary provisioning card;

FIG. 5 is communicational flow diagram of an exemplary mechanism for granting network access;

FIG. 6 is a flow diagram of an exemplary card provisioning mechanism;

FIG. 7 is a flow diagram of an exemplary device provisioning mechanism;

FIG. 8 is a flow diagram of an exemplary authentication mechanism;

FIG. 9 is a flow diagram of an exemplary network rights withdrawal; and

FIG. 10 is a flow diagram of another exemplary network rights withdrawal.

### DETAILED DESCRIPTION

The following description relates to the provisioning, both for network access, and with regard to other capabilities, of devices through the use of removable storage and execution media. In one embodiment, the removable storage and execution media can take the form of an inexpensive card that can comprise both writable storage and a limited processing unit for executing computer-executable instructions. Such a card can be provided with authentication information by a trusted computing device and can further be provided with other provisioning information. Subsequently, the card can be connected to a host device and can, through the networking capabilities of the host device, communicate with the trusted computing device to authenticate itself to the trusted computing device. Once authenticated, the trusted computing device can provide for the host device to be granted access to the network, such as by adding it to the list of devices being granted network access, as would be maintained by one or more network access points. Should the need arise, the card, or the trusted computing device, can revoke network access rights from the host device on an individual basis, without affecting or requiring modification to any other device connected to the network. Additionally, the card can provide other provisioning information to its host device and can, itself, provision the host device via computer-executable instructions executed by the processing unit of the card itself.

The techniques described herein focus on, but are not limited to, the provisioning of devices within the context of a small network, such as a home or small-office network. Indeed, none of the below described mechanisms are any less applicable in larger-scale networks and, in fact, may be used in conjunction with other large-scale network provisioning mechanisms. For example, the embodiments described below could be used by network service providers to further secure their overall wide-area network by increasing the network security implemented by each of their customers. Consequently, below references to small networks, or wireless networks, are meant to be illustrative only, and are not intended to limit the described embodiments to such contexts.

Although also not required, the descriptions below will be in the general context of computer-executable instructions, such as program modules, being executed by one or more computing devices. More specifically, the descriptions will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments where tasks are performed by remote processing devices that are linked through a communications network. In a distributed computing environment, program modules may be located in both local and remote memory storage devices.

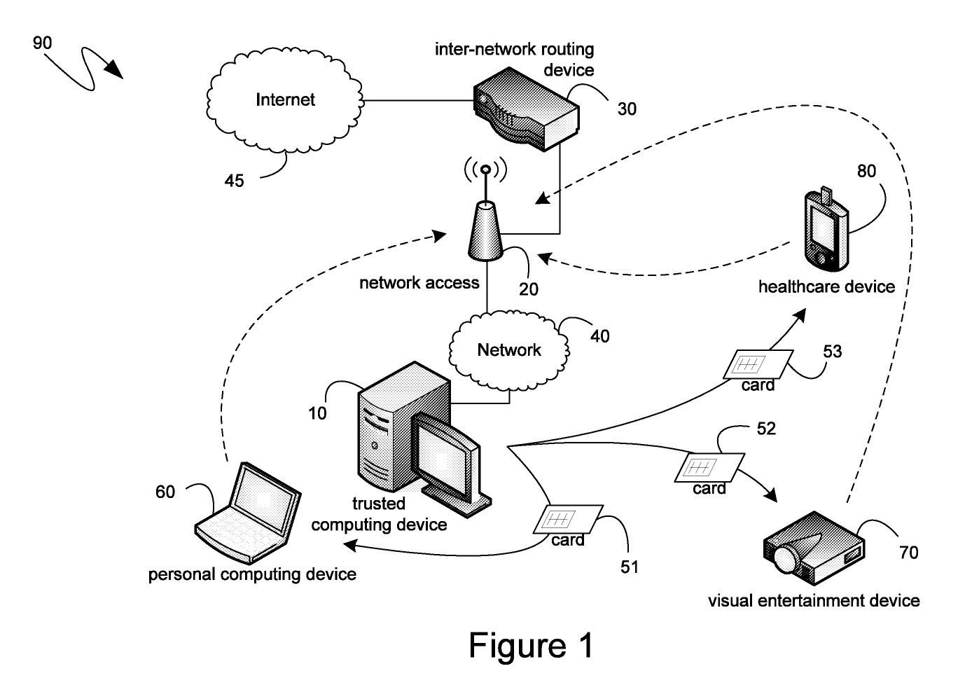

Turning to FIG. 1, an exemplary network system 90 is illustrated comprising a network 40 connected to a larger network, such as the Internet 45, via an inter-network routing device 30. The network 40 is shown comprising a trusted computing device 10 connected to a network access point 20, which additionally can be provisioned to host a personal computing device 60, a visual entertainment device 70 and a healthcare device 80, providing each access to the network 40 and further to other networks connected thereto, such as the Internet 45.

Traditionally, access to the network 40 would be granted by the network access point 20 upon entry of a proper password or passcode. Thus, for example, if a user of the trusted computing device 10 desired to enable the personal computing device 60 to connect to the Internet 45 in a secure manner, such a user could use the trusted computing device to set up a passcode at the network access point 20 and could subsequently provide that same passcode to the personal computing device 60. When the personal computing device 60 attempted to connect to the network access point 20, it would be prompted for a passcode and, upon entry of a correct passcode, the personal computing device 60 could be granted access to the network 40, including access to the Internet 45 via the inter-network routing device 30.

Such a system, however, can be compromised if a rogue device or user becomes aware of the correct passcode. While the passcode can be strengthened, it can, thereby, become more difficult for a user to remember and correctly provide to the personal computing device 60. Even if known mechanisms are used to aid the user in transferring the strengthened passcode, such as through portable and removable storage media, the user still cannot bar only one device from the network without requiring a change to all of the other devices. For example, if the user were to change the passcode, all of the legitimate devices would likewise need to update their copy of the passcode so as to retain their network access.

Additionally, as will be known by those skilled in the art, the mere setting up of a device in order to communicate with the network access point 20 in the first place can be a challenge, especially for non-traditional network devices. For example, the healthcare device 80, such as a network-enabled blood glucose monitor, may have an unusual or non-standard interface for accepting entry of network information, such as network identifiers, the address of the network access point 20, and other like information. Thus, even if the user could easily provide a passcode to the healthcare device 80, the user may still struggle to properly connect the device to the network access point 20.

In one embodiment, therefore, access to the network 40 can be granted via the use of removable storage and execution media, such as cards 51, 52 and 53. In particular, each of the cards 51, 52 and 53 can initially be communicationally connected to the trusted computing device 10. Computer-readable modules executing on the trusted computing device 10, or executing elsewhere and utilizing the trusted computing device, can store on the cards 51, 52 and 53 authentication information that can be subsequently used to authenticate any device to which the cards are subsequently connected for the purpose of granting that other device access to the network 40.

Once the cards 51, 52 and 53 have been provisioned by the trusted computing device 10, they can be communicationally connected to a device that is to be allowed to join the network 40, such as through the network access point 20. For example, in the illustrative network system 90 of FIG. 1, the cards 51, 52 and 53 can, after receiving the authentication information from the trusted computing device 10, be connected to devices 60, 70 and 80, respectively, each of which are to be granted access to the network 40. Subsequently, each of the cards 51, 52 and 53 can initiate communication with the trusted computing device 10 for purposes of provisioning their respective host devices 60, 70 and 80, respectively, for network access.

In one embodiment, each of the cards 51, 52 and 53 can request, and receive, from their host devices 60, 70 and 80, respectively, access to the networking hardware of such host devices so as to initiate communication with the trusted computing device 10. For example, card 51, upon being communicationally connected to the personal computing device 60, can request access to the networking hardware and networking software of the personal computing device, and can utilize the same to communicate with the trusted computing device, such as via the network access point 20.

Once in communication with the trusted computing device 10, each card, such as cards 51, 52 and 53 can authenticate themselves to the trusted computing device, such as through predetermined mechanisms that were provided for when the trusted computing device stored the authentication information onto the card initially. After authenticating themselves to the trusted computing device 10, the cards, such as cards 51, 52 and 53, can provide sufficient information regarding their host device, such as devices 60, 70 and 80 to enable the trusted computing device, or some other mechanism, to modify the network access criteria implemented by the network access point 20 to allow devices 60, 70 and 80 to join the network 40. Alternatively, the cards, such as cards 51, 52 and 53, can receive information from the trusted computing device 10 that can be provided to each of their host devices, such as devices 60, 70 and 80, to enable the host device to configure itself in order to be granted access to the network 40.

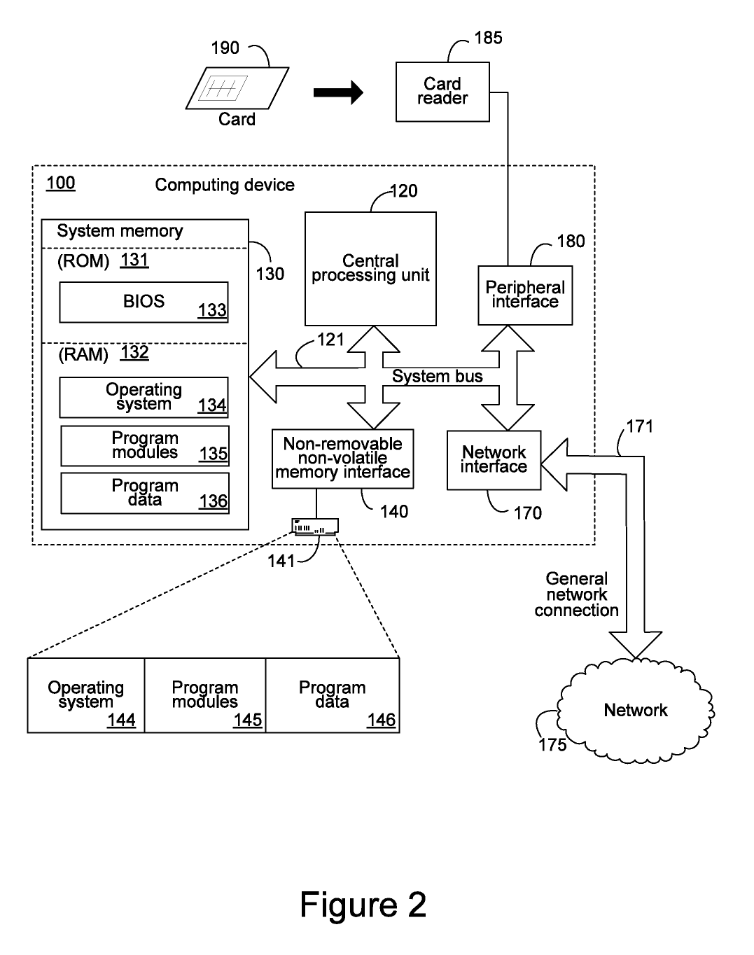

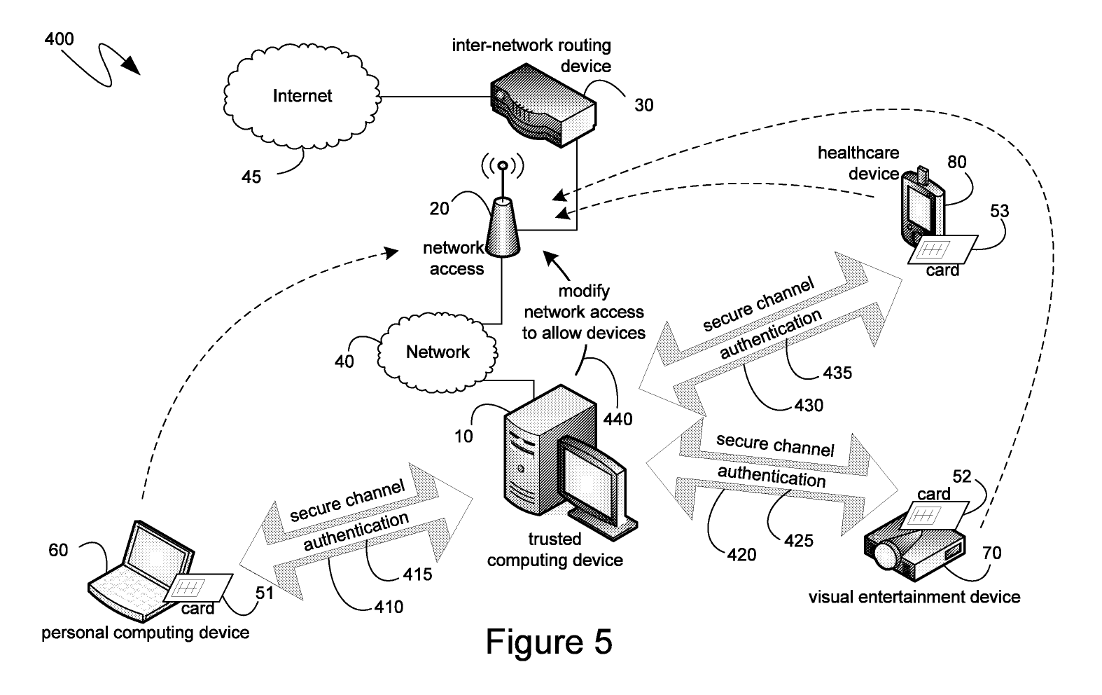

The authentication information and mechanisms will be described in further detail below with reference to FIGS. 2 through 10. FIGS. 2, 3 and 4 provide greater information regarding contemplated computing devices, networkable devices and authentication cards. FIGS. 5 through 10 provide greater information regarding authentication mechanisms that can utilize these, or other, devices.

With reference to FIG. 2, an exemplary computing device 100 is illustrated. The computing device 100 can represent any of the computing devices 10, 60, 70 or 80 shown in FIG. 1, as well as any of the computing devices referenced below. The exemplary computing device 100 can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates an operating system 134, other program modules 135, and program data 136.

The computing device 100 typically includes a variety of computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The computing device 100 may also include other removable/non-removable, volatile/nonvolatile computer storage media. By way of example only, FIG. 2 illustrates a hard disk drive 141 that reads from or writes to non-removable, nonvolatile magnetic media. FIG. 2 further illustrates a card reader 185 that reads from or writes to a card 190, which can be any one of the cards 51, 52 or 53, described above with reference to FIG. 1. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, while the card reader 185 is typically connected to the system bus through a peripheral interface 180.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing an operating system 144, other program modules 145, and program data 146. Note that these components can either be the same as or different from operating system 134, other program modules 135 and program data 136. Operating system 144, other program modules 145 and program data 146 are given different numbers here to illustrate that, at a minimum, they are different copies.

Of relevance to the descriptions below, the computing device 100 may operate in a networked environment using logical connections to one or more remote computers. For simplicity of illustration, the computing device 100 is shown in FIG. 2 to be connected to a network 175 that is not limited to any particular network or networking protocols and can include either or both of the network 40 or the Internet 45, described above with reference to FIG. 1. The logical connection depicted in FIG. 2 is a general network connection 171 that can be a local area network (LAN), a wide area network (WAN) or other network. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

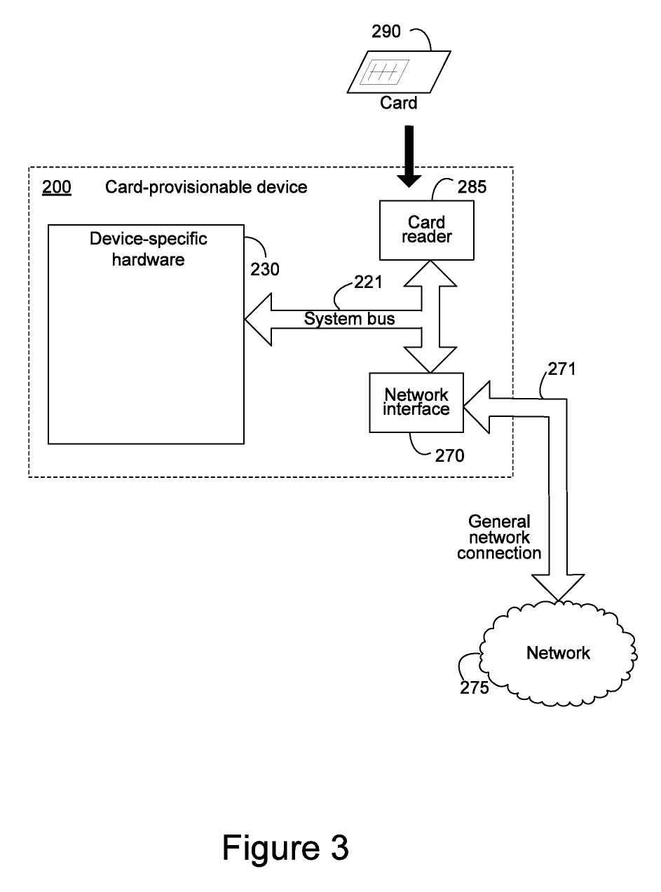

Turning to FIG. 3, a card-provisionable device 200 is shown, which can be illustrative of any of the devices 60, 70 or 80 of FIG. 1, or any other computing device capable of being provisioned in association with a card, such as card 290. The exemplary card-provisionable device 200 can include, but is not limited to, a card reader 285, a network interface 270, device-specific hardware 230 and a system bus 221 that communicationally couples various system components. The system bus 221 may be any of several types of bus structures including a memory bus or memory controller, a peripheral bus, and a local bus using any of a variety of bus architectures. Similarly, the card reader 285 can be any of several types of card readers, including internal or external card readers, and including flash memory card or dedicated memory card readers.

The device-specific hardware 230 comprises hardware directed to the primary purpose of the card-provisionable device 200. For example, in the case of the visual entertainment device 70, the device-specific hardware 230 can comprise image generation and display hardware, including imaging circuitry, a display, a lens and a light source. Similarly, in the case of the healthcare device 80, the device-specific hardware 230 can comprise, for example, blood glucose measuring hardware.

The logical connection to the network 275 depicted in FIG. 3 is a general network connection 271 that can be a local area network (LAN), a wide area network (WAN) or other network. The card-provisionable device 200 is connected to the general network connection 271 through a network interface or adapter 270 which is, in turn, connected to the system bus 221. As before, it will be appreciated that the network connections shown are exemplary and other means of establishing a communications link between computing devices may be used.

In one embodiment, as indicated previously, components executing on the card 290 can be granted access to the network interface 270 for purposes of communicating with a trusted computing device that had previously provisioned the card. For example, the card reader 285 can comprise dedicated elements that can respond to expected requests from the card 290, such as a request for access to the network interface 270 through the system bus 221. Alternatively, the card-provisionable device 200 can further comprise a CPU, analogous to that described above, that can be communicationally connected to the system bus 221 and that can receive and respond to requests from the card 290.

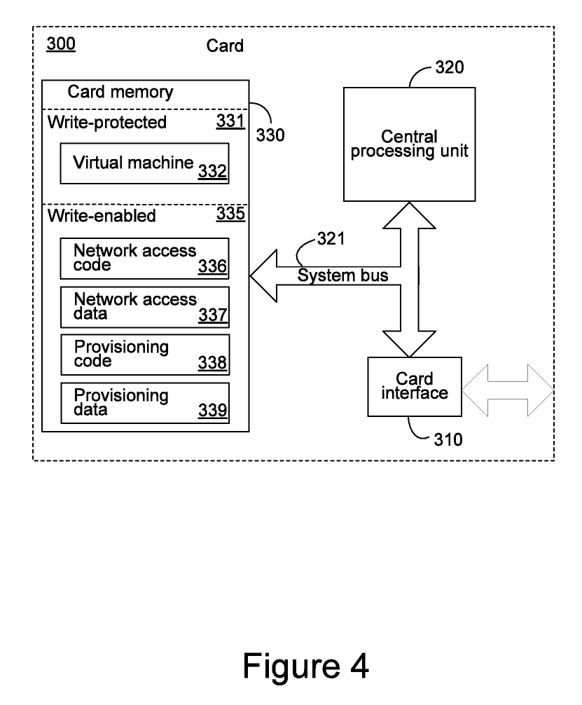

An exemplary card 300 and illustrative components are illustrated in FIG. 4. The exemplary card 300 of FIG. 4 can represent any of the above-described cards, including cards 51, 52 and 53 of FIG. 1, card 190 of FIG. 2, or card 290 of FIG. 3. The exemplary card 300 can include, but is not limited to, a card interface 310, one or more central processing units (CPUs) 320, a card memory 330 and a system bus 321 that couples various card system components including the card memory and the card interface to the processing unit. The system bus 321 may be any of several types of bus structures including a memory bus or memory controller, a peripheral bus, and a local bus using any of a variety of bus architectures.

The card memory 330 can include computer storage media in the form of volatile and/or nonvolatile memory such as write-protected memory 331 and write-enabled memory 335. The write-protected memory 331 can have stored thereon a virtual machine 332 that can comprise the basic routines that enable the card 300 to execute computer-executable instructions, such as the network access code 336 and the provisioning code 338, described further below, on the CPU 320. The virtual machine 332 can provide for the execution of computer-executable instructions that are written in a standard programming language, or in a customized, or limited, programming language. Alternatively, the virtual machine 332 can provide for the execution of computer-executable instructions that are in an intermediate, or post-compiled form.

Write-enabled memory 335 typically contains data and/or program modules that are immediately accessible to and/or presently being operated on by processing unit 320. By way of example, and not limitation, FIG. 4 illustrates network access code 336, network access data 337, provisioning code 338 and provisioning data 339 stored within the write-enabled memory 335. As will be described in further detail below, the network access code 336 can comprise computer-executable instructions that, when executed by the CPU 320, in conjunction with the virtual machine 332, enable the card 300 to communicate, through the card interface 310 and the network interface 270 of a host device, with the trusted computing device 10.

The network access data 337 can comprise information that can be used by the network access code 336 to gain access to the network 40, such as, for example, the network name or other network identifier, the address of the trusted computing device on the network, and any passwords or passcodes needed to join the network sufficiently to enable communication with the trusted computing device. Network access data 337 can also comprise information needed to authenticate the card 300 to the trusted computing device 10, such as unique passwords, passcodes, challenge-response data and the like. The portion of the network access data 337 that enables an individual card, such as card 300, to authenticate itself to the trusted computing device 10 can be distinct from the portion of the network access data 337 that enables the card to join the network 40 for purposes of communicating with the trusted computing device. For example, the network 40 can be password protected, and the network access data 337 can include an appropriate password, while the trusted computing device 10 can provision a card, such as card 300, to be able to authenticate itself through a series of challenges and appropriate responses that are completely independent of the network password, and which can also be part of the network access data 337.

In addition to the network access code 336 and the network access data 337, the card memory 330 can further comprise provisioning code 338 and provisioning data 339 that can enable the device hosting the card 300 to provision itself, or enable the card 300 to provision it. In one embodiment, both the provisioning code 338 and the provisioning data 339 can be stored on the card memory 330 by the trusted computing device 10. In an alternative embodiment, the provisioning data 339 can be provided by the trusted computing device while the provisioning code 338 can be provided by another entity, such as the card manufacturer, and can be sufficiently general to enable the provisioning of multiple host devices.

The provisioning data 339 can vary depending on the type of host device for which the card 300 was provisioned. For example, if the card 300 was intended for a visual entertainment device, such as visual entertainment device 70, the provisioning data 339 could comprise settings relevant to that device, such as, for example, a listing of the video channels the user has subscribed to, information regarding the source devices connected to the visual entertainment device, and predetermined settings for visual display parameters, including, but not limited to, contrast, black levels, color intensity, and horizontal and vertical offsets. If, on the other hand, the card 300 was intended for a healthcare device, such as healthcare device 80, the provisioning data 339 might comprise a fewer number of settings, but could still comprise settings relevant to such a device, such as, for example, language and display preferences.

The provisioning code 338 can, in one embodiment, likewise vary depending on the type of host device for which the card 300 was provisioned. Such varying provisioning code 338 can be generated by the trusted computing device 10, or it can be obtained by the trusted computing device from external sources, such as from the Internet 45. For example, a user can provide their own code to act as some or all of the provisioning code 338. Alternatively, the user can be provided with a simple interface, such as a graphical, object-oriented programming interface, that can then generate provisioning code 338 based on the user's input.

Initially, as indicated in FIG. 1, and described above, a card, such as cards 51, 52 and 53, each of which can comprise the elements of exemplary card 300, can be provisioned by a trusted computing device, such as trusted computing device 10, which, in turn, can comprise the elements of the exemplary computing device 100 of FIG. 2. The trusted computing device 10 can, via the peripheral interface 180, the card reader 185, and the card interface 310, store onto the write-enabled memory 335, the network access code 336, the network access data 337 and, optionally, the provisioning code 338 and provisioning data 339. In one embodiment, a user interface presented to the user of the trusted computing device 10 can guide that user through a setup process. For example, such a user interface could enable the user to select from among a variety of authentication mechanisms with which a card 300 could authenticate itself to the trusted computing device 10. Similarly, the user interface could enable the user to select from a pre-populated list of devices for which provisioning data was available. The user's selections could then inform the specific network access code 336, network access data 337 and, optionally the provisioning code 338 and the provisioning data 339 written to a card 300 by the trusted computing device 10. Once a card, such as cards 51, 52 or 53 of FIG. 1, was provisioned by the trusted computing device 10, it could be communicationally coupled to a device, such as devices 60, 70 or 80, to provide the device with access to the network 40.

Turning to FIG. 5, a network system 400 is illustrated showing an exemplary set of communications subsequent to the communicational coupling of the cards 51, 52 and 53 with the devices 60, 70 and 80, respectively, as shown in FIG. 1. As indicated previously, after the cards 51, 52 and 53 have been communicationally coupled with the devices 60, 70 and 80, respectively, each card can request, of its particular host device, access to that host device's network communication hardware. More specifically, the network access code 336, as executed by the CPU 320, via the virtual machine 332, can request access to the network interface 270, and any applicable network communication stack, for purposes of communicating with the trusted computing device 10. Once such communication is established, a card 300, such as the cards 51, 52 and 53, can authenticate itself to the trusted computing device 10 by using the network access code 336 and network access data 337 provisioned onto the card by the trusted computing device.

Since the devices to which a card 300 can be communicationally coupled may be untrusted, the authentication of the card to the trusted computing device 10 can occur via a secure channel, such as secure channels 410, 420 and 430, established between cards 51, 52 and 53, respectively, and the trusted computing device 10. In one embodiment, the establishment of a secure channel, such as secure channels 410, 420 and 430, can occur via standard Secure Sockets Layer (SSL) communications. In an alternative embodiment, however, non-standard mechanisms can be used to establish a secure channel, such as secure channels 410, 420 and 430, because the trusted computing device 10 acts as both one of the endpoints of such secure channels, and as the provisioning agent for the card, such as cards 51, 52 and 53, that acts as the other endpoint of the secure channel, thereby enabling the trusted computing device to select even non-standard security mechanisms so long as the card is appropriately provisioned beforehand.

Once a secure channel, such as secure channels 410, 420 and 430, is established, the above described authentication between the card, such as cards 51, 52 and 53, respectively, and the trusted computing device 10, can occur via the secure channel. Thus, as illustrated in FIG. 5, authentication communications 415, between card 51 and the trusted computing device 10, can occur via the secure channel 410. Likewise, authentication communications 425 can occur via the secure channel 420 and authentication communications 435 can occur via the secure channel 430.

Once a card, such as cards 51, 52 and 53 have authenticated themselves to the trusted computing device 10, the trusted computing device can grant, to the device hosting the card, such as devices 60, 70 and 80, respectively, access to the network 40. In one embodiment, such network access can be granted by communications, such as communication 440, between the trusted computing device 10 and one or more network access points, such as network access point 20. For example, the trusted computing device 10 can receive, from a card, such as cards 51, 52 or 53, the network adapter address, or other identifier, of the host device of the card, such as devices 60, 70 and 80, respectively. That identifier can be provided, by the trusted computing device 10 to network access points, such as network access point 20, and can be added to a network access control list or similar mechanism, thereby specifying that the network access points are to allow the identified device access to the network 40.

In an alternative embodiment, the trusted computing device 10 can communicate with the card, such as cards 51, 52 or 53, and provide to the card information that the card can then provide to its host device, such as devices 60, 70 and 80, respectively, to enable the host device to gain access to the network 40. For example, the network 40 may be protected by a frequently changing password. In such a case, the trusted computing device 10 can, on a periodic basis, provide a new password to the card, such as cards 51, 52 or 53, which can, in turn, provide the new password to their host devices, such as devices 60, 70 and 80, respectively, thereby enabling the host devices to gain and maintain access to the network 40.

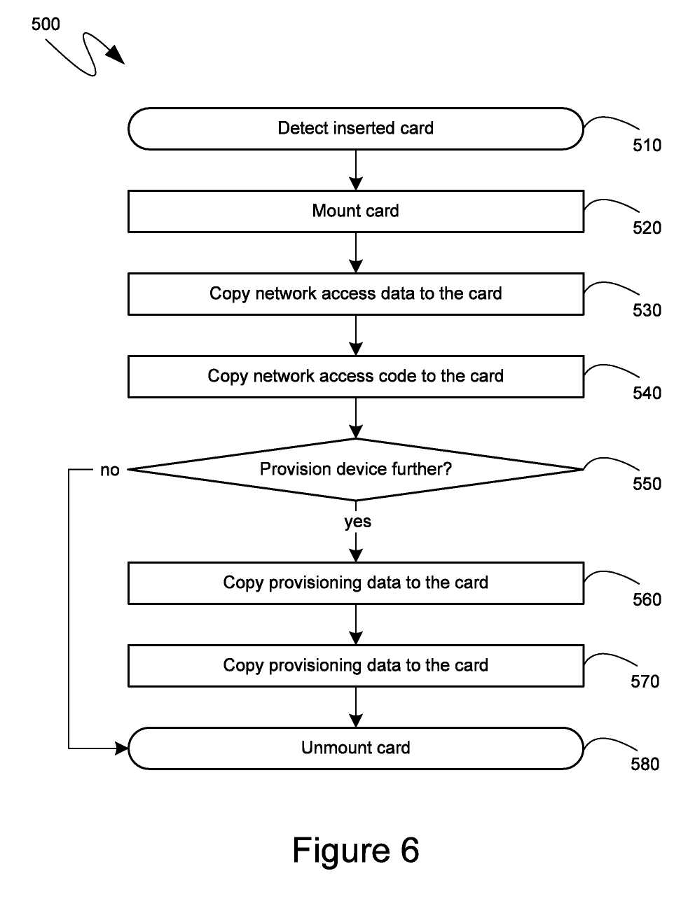

The above described mechanisms are further illustrated with reference to the flow diagrams 500, 600, 700 and 800 of FIGS. 6, 7, 8 and 9, respectively. Turning to FIG. 6, flow diagram 500 illustrates an exemplary series of steps by which a card 300, such as cards 51, 52 and 53, can be provisioned by a computing device 100, such as the trusted computing device 10. Initially, at step 510, the computing device 100 can detect the insertion, or other communicational connection, of the card 300. The connected card 300 can then, at step 520, be mounted, such that the computing device 100 can be granted access to the card memory 330 or, at least to the write-enabled portion 335 of the card memory. Any appropriate network access data 337 that can enable the card 300 to gain sufficient network access to communicate with the trusted computing device 10, and that can enable the card to authenticate itself to the trusted computing device can be copied by the computing device 100 to the write-enabled card memory 335 at step 530. Similarly, any appropriate network access code 336 that can enable the card 300 to gain sufficient network access to communicate with the trusted computing device 10 and authenticate itself can be copied by the computing device 100 to the write-enabled card memory 335 at step 540. Of course, as will be recognized by those skilled in the art, the steps 530 and 540 can be reversed with equal effect, as their order is not relevant to the operations described.

If the user desires to further provision the device to which the card will be communicationally coupled, such provisioning data and appropriate provisioning code can likewise be stored on the card. Thus, as step 550, a check can be made to determine if the user desires to further provision the device. If the user does not wish to do so, processing can proceed to complete and unmount the card at step 580. However, if the user does desire to provision the device further, the user can provide relevant information to the trusted computing device 10. For example, the user can specify the type of device, or the specific device, to the trusted computing device 10 to enable the computing device to determine if any provisioning data exists, such as in the user's own files, or in a central repository, such as on a network-accessible storage medium. Alternatively, the user can choose to provide their own provisioning data, such as through a predefined template presented by the trusted computing device 10. In one embodiment, the predefined template can be appropriate for the type of device specified by the user, even if no specific provisioning data is available for such a device. Thus, for example, a template for a visual entertainment device, such as visual entertainment device 70, can provide for user selection of visual content available to the user, such as cable channels, or of input devices that the user may connect to the visual entertainment device. Conversely, a template for a healthcare device, such as healthcare device 80, may comprise fewer options, such as merely enabling the user to enter their identification or select a default language. Once such provisioning data 339 is identified or created at step 550, the trusted computing device 10 can copy it to the card 300 at step 560.

Provisioning code 338 can be provided to the card 300 by the trusted computing device 10 in an analogous manner. As indicated previously, in one embodiment, the provisioning code 338 can be sufficiently general to provide for the provisioning of many types of devices, and, in such a case, it need not be modified or be provided by the trusted computing device 10. In an alternative embodiment, however, the trusted computing device 10 can obtain provisioning code 338 by obtaining information from the user and then either identifying and obtaining appropriate provisioning code, such as from the Internet 45, or generating its own provisioning code 338, based on the user's input. Once the provisioning data 339 and, if appropriate, the provisioning code 338 is stored on the card 300, the card can be unmounted at step 580 to enable the computing device to cease communications with the card in an appropriate manner.

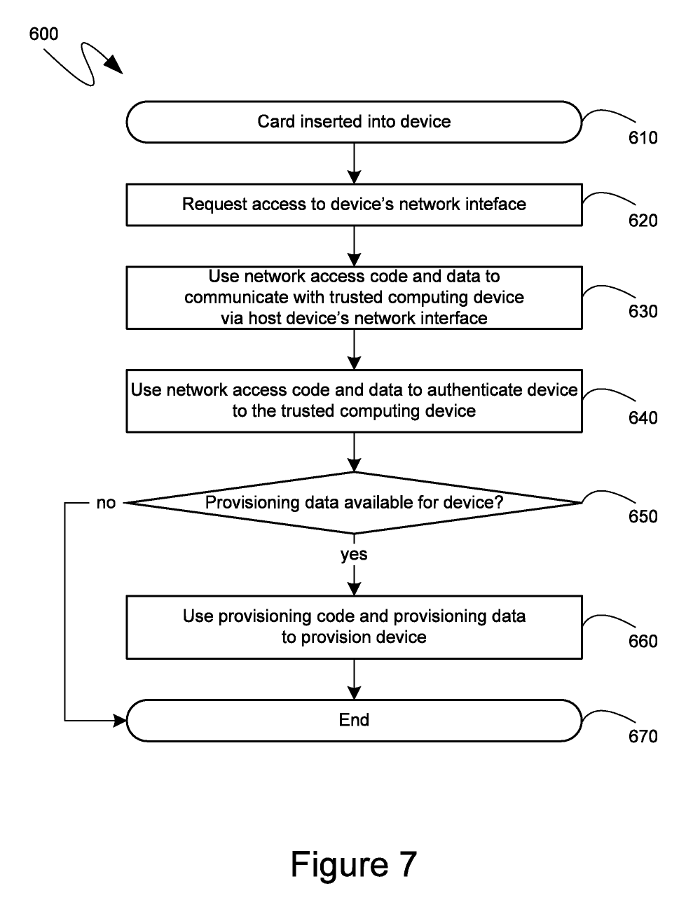

Once the card 300 has been provisioned, it can be communicationally coupled to a device that seeks to be granted network access. The flow diagram 600 of FIG. 7 illustrates an exemplary series of steps contemplated by an embodiment for providing network access to a device. Initially, at step 610, the card 300 can be inserted, or otherwise communicationally coupled, to a card-provisionable device 200. At step 620, the card 300 can request access to the network interface 270 of the card-provisionable device 200, including access to any appropriate network stack or similar code executing on the card-provisionable device.

Once the card 300 has access to the networking hardware and appropriate networking software of the card-provisionable device 200, it can, at step 630, make use of such networking functionality with the previously stored network access code 336 and network access data 337 to communicate with the trusted computing device 10. In one embodiment, the communications of step 630 can comprise the establishment of a secure communication channel. While communicating with the trusted computing device 10, the card 300 can, at step 640, use the network access code 336 and network access data 337 to authenticate itself to the trusted computing device 10 and, thereby, cause the card-provisionable device 200 to which it is communicationally connected to be granted access to the network 40.

As indicated previously, the card-provisionable device 200 can be granted access to the network 40 through actions by the trusted computing device 10, such as the addition of the card-provisionable device's identifier to the list of allowed clients of a network access point, such as network access point 20. Alternatively, the card-provisionable device 200 can be granted access to the network 40 through a combination of actions by both the trusted computing device 10 and the card 300, in which case step 640 can further comprise relevant aspects of those other actions. Thus, for example, if the card-provisionable device 200 was granted access to the network 40 by receiving passwords from the card 300, the receipt of such passwords, and their entry into the appropriate software of the card-provisionable device, can be encompassed by step 640.

At step 650 a determination can be made if the card-provisionable device 200 can be further provisioned by the card 300, such as, for example, by obtaining pre-selected user preferences from the card. In one embodiment, the card-provisionable device 200 can actively request, or invite, the provision of such information from the card 300. In an alternative embodiment, the decision at step 650 can be based on an offer to the card-provisionable device 200 that was initiated by the card 300. In particular, the provisioning code 338 can be executed by the CPU 320 of the card 300 to enable the card to provision the card-provisionable device 200 without involvement from the device 200. Thus, for example, provisioning code 338 executing on the card 52 can identify appropriate data storage locations in the visual entertainment device 70 and can overwrite those locations with the user specified values for, for example, channel names or color calibration values. Similarly, provisioning code 338 executing on the card 53 could identify appropriate features of the healthcare device 80 and activate or deactivate those features, as instructed by the provisioning data 339 selected by the user.

Irrespective of the precise provisioning mechanism, whether executed by the card-provisionable device 200 or the card 300, if the card-provisionable device can accept some or all of the provisioning data 339, it can be provided to the device from the card 300 at step 660. Subsequently, the relevant processing can end at step 670. As before, the performance of steps 650 and 660 is not limited to occurring after the performance of steps 620, 630 and 640, since, as will be recognized by those skilled in the art, the provisioning of the card-provisionable device 200 with the provisioning data 339 is not dependent upon the granting of network access. Consequently, in other contemplated embodiments, steps 650 and 660 can occur prior to steps 620, 630 and 640, or even in parallel with them.

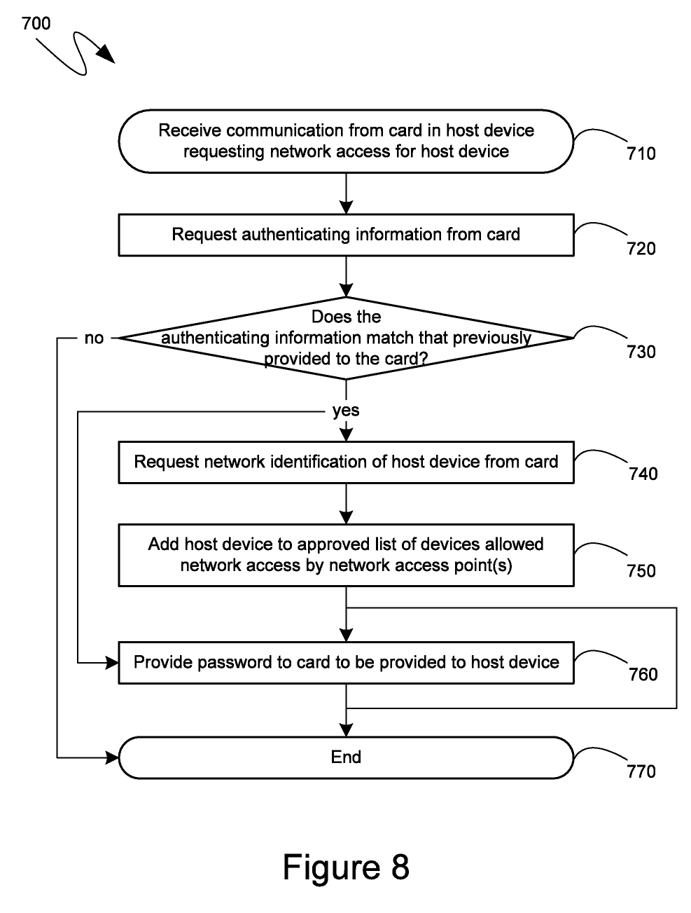

As indicated, the trusted computing device 10 can provide access to the network 40 to devices, such as devices 60, 70 and 80, after authenticating an associated card, such as cards 51, 52 and 53, respectively. FIG. 8 comprises a flow diagram 700 illustrating an exemplary series of steps for providing such network access to the devices 60, 70 and 80. Initially, at step 710, the trusted computing device 10 can receive communications from a card 300 communicationally connected to a card-provisionable device 200. In one embodiment, step 710 can also comprise the establishing of a secure communication channel between the card 300 and the trusted computing device 10.

Subsequently, at step 720 the trusted computing device 10 can receive authentication information from the card 300. In one embodiment, the trusted computing device 10 can request such information from the card 300. In an alternative embodiment, the card 300 can provide such information to the trusted computing device 10 without an explicit request. If, at step 730, the trusted computing device 10 cannot verify the information provided at step 720, then no network access need be granted to the card-provisionable device 200 and the relevant processing can end at step 770, as shown. If, however, at step 730, the trusted computing device 10 verifies that the information provided at step 720 is consistent with the network access code 336 and network access data 337 previously provided to the card 300, the trusted computing device can thereby authenticate the card and can proceed to grant, to the card-provisionable device 200, access to the network 40.

In one embodiment, the granting of access to the network 40 can include steps 740 and 750, whereby, at step 740, the trusted computing device 10 requests a network identification of the card-provisionable device 200 from the card 300 and, at step 750, the trusted computing device communicates with network access points, such as network access point 20, to indicate to the network access points that devices matching the provided network identification are to be allowed to join the network. As with step 720, the card 300 can provide the network identification information of the card-provisionable device 200 without an explicit request and, consequently, step 740 can be considered as optional.

In an alternative embodiment, rather than modifying the list of devices allowed onto the network 40, as would be maintained by network access points, such as the network access point 20, the card-provisionable device 200 can be granted access to the network via the provision of passwords from the trusted computing device 10 to the card 300, as indicated by step 760. For example, the network 40 can be protected by requiring a changing password from devices seeking to gain access. Such an updated password can be provided by the trusted computing device 10 to cards, such as cards 51, 52 and 53, that have authenticated themselves, thereby enabling devices 60, 70 and 80, respectively, access to the network 40.

In a further alternative embodiment, the security provisions described above can be combined for additional network security. Thus, steps 740 and 750 can be performed in conjunction with, and not instead of, step 760. In such an embodiment, the network access points, such as network access point 20, can still be updated by the trusted computing device 10, at step 750, with the network identification information of the card-provisionable device 200, but the card-provisionable device can further be provided with information, such as a password, via the card 300 at step 760 since access to the network 40 can require both a correct password and the presence of the device's network identifier within a list of allowable devices. Relevant processing can then end at step 770 as shown.

While devices, such as devices 60, 70 and 80, that seek to obtain access to the network 40 can be provisioned with network access via the card-implementing mechanisms described above, the use of cards, such as cards 51, 52 and 53, respectively, can enable the trusted computing device 10 to likewise revoke the network access of specific devices without impacting the network access of other devices. In one embodiment, various detection mechanisms can be used to automatically trigger the revocation of a device's network access. For example, a device's network access can be triggered if it is unexpectedly removed from the network or if exhibits rogue behavior, such as utilizing a significant share of the network's bandwidth for an extended period of time. In another embodiment, a user can manually trigger a revocation of a device's network access, such as if the user noticed the device missing, or if the user was preparing to sell the device.

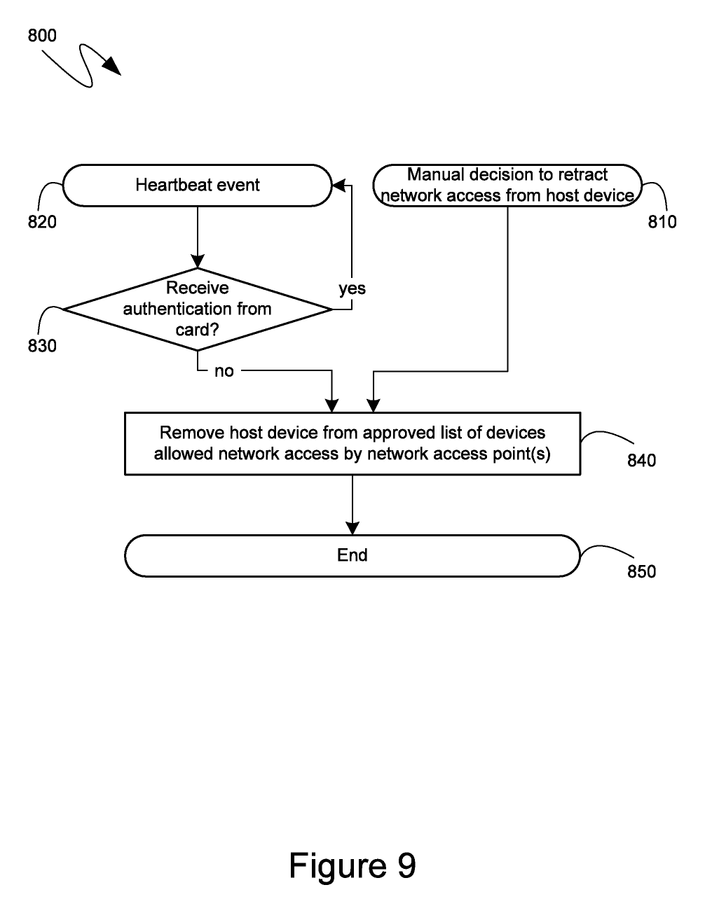

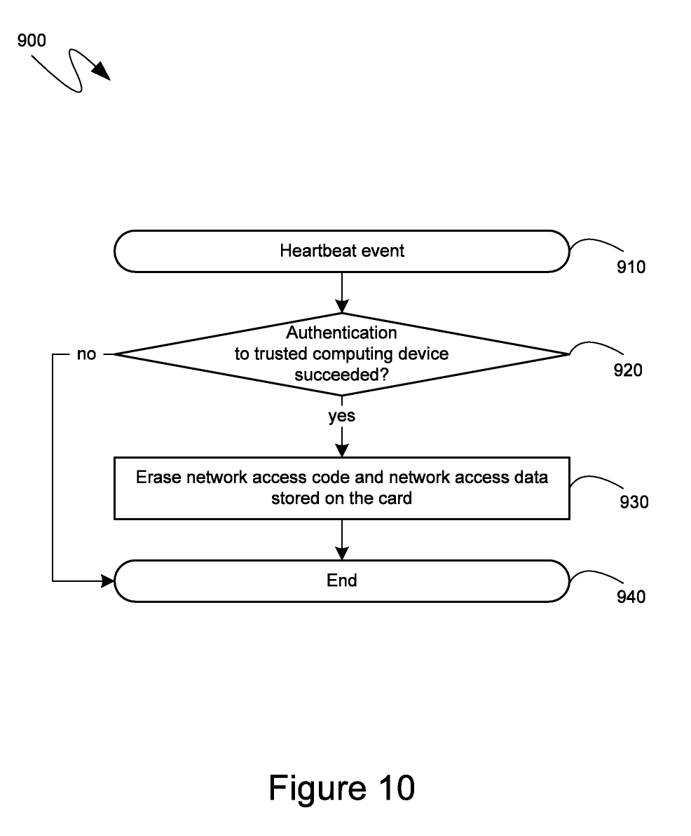

Either of the above described embodiments can accomplish the network access revocation through either mechanisms acting at the host device, the trusted computing device 10, or some combination thereof. For illustration, flow diagram 800 of FIG. 9 provides an exemplary series of steps such as could be performed by the trusted computing device 10, while flow diagram 900 of FIG. 10 provides an exemplary series of steps such as could be performed by a card 300 in a card-provisionable device 200. However, as will be recognized by those skilled in the art, the specific circumstances that can trigger a revocation of network access rights can be varied and highly dependent upon specific situations. As such, the triggering steps of FIGS. 9 and 10 are meant to be illustrative only, and are not intended to suggest limitations thereon.

Turning to FIG. 9, the flow diagram 800 illustrates a revocation of network access rights that can be triggered either by a manual decision at step 810 or a heartbeat event at step 820. For example, a user can, at step 810, decide to revoke the network access rights of a device, such as the portable computing device 60, because the user has decided to sell that device. Similarly, a heartbeat event at step 820 can be any event whereby a check is performed, such as by the trusted computing device 10, to verify that each device currently accessing the network 40 is authorized to do so. Subsequent to such a heartbeat event at step 820, a check can be performed at step 830 to verify that appropriate authentication information was received from a card 300 connected to the card-provisionable device 200 currently accessing the network 40. If appropriate card-based authentication information was received at step 830, such as by utilizing the previously provided network access code 336 and the network access data 337, the host device's network access can remain unchanged and processing can return to the heartbeat event at step 820. In one embodiment, the time between heartbeat events can be adjustable to avoid overburdening the card-provisionable device 200 or the card 300.

However, if, at step 830, no card-based authentication is received, then, at step 840, the trusted computing device 10 can revoke the network access rights of the relevant device. The mechanism by which network access rights can be revoked can vary depending on the security protecting the network 40. For example, if the network 40 is protected by a network access control list, such that only devices whose network identifiers are on the list are allowed to connect to the network 40, then, at step 840, the trusted computing device 10 can notify the network access points, such as access point 20, that the device from whom no appropriate authentication was received at step 830 is to be removed from the network access control list. Similarly, if the network 40 is protected by a variable password, then, at step 840, the trusted computing device 10 can no longer provide the new password to the device from whom no appropriate authentication was received at step 830, thereby revoking that device's network access rights. Subsequently, once the device's network access rights are removed at step 840, the relevant processing can end at step 850.

A device can also have its network access rights revoked by actions of the card 300. The flow diagram 900 of FIG. 10 illustrates one such exemplary card-based network access revocation. As shown, at step 910, a heartbeat event can occur that provides a basis for a triggering mechanism for the card 300 to revoke a card-provisionable device's network access. The heartbeat event of step 910 can be any periodic monitoring or checking event that could trigger a card-based network access revocation. For example, in one embodiment, the heartbeat event of step 910 can be an attempt by the card 300 to authenticate itself to the trusted computing device 10, or to otherwise contact the trusted computing device. In an alternative embodiment, the heartbeat event of step 910 can be a periodic monitoring of the card-provisionable device 200, to which the card 300 is communicationally coupled, to verify that the device is not performing in an unusual or improper manner. In another alternative embodiment, the heartbeat event of step 910 can be a check to verify that the network 40 is still contactable, or some other similar check to verify that the card-provisionable device 200, to which the card 300 is communicationally coupled, has not been stolen.

If the heartbeat event at step 910 does not comprise any abnormal or unexpected occurrences, the decision at step 920 can determine to leave the card-provisionable device's network access unchanged and the relevant processing can end at step 940. However, if, step 920 determines that the card-provisionable device's network access rights should be revoked, the card 300 can perform an appropriate action at step 930, such as erasing the network access code 336 and the network access data 337 stored on the card. The specific check performed at step 920 can depend on the type of heartbeat event, or other triggering mechanism, being used at step 910. For example, as illustrated in FIG. 9, if the heartbeat event at step 910 is an attempt to authenticate the card 300 with the trusted computing device 10, then, at step 920, a check can be made to determine if such an authentication was successful. Alternatively, if the heartbeat event at step 910 was a monitoring of the behavior of the card-provisionable device 200, to which the card 300 is communicationally coupled, then the check, at step 920, can be a determination if the card-provisionable device is behaving in an unexpected or improper manner. Likewise, if the heartbeat event at step 910 was an attempt to verify that the card-provisionable device 200, to which the card 300 is communicationally coupled, has not been stolen, then, at step 920, a determination can be made whether the data from the heartbeat event suggests that the device has been stolen.

As indicated, if the determination, at step 920, indicates that an event has occurred, or a state has been entered, wherein the network access of the host device should be revoked, the card 300 can, for example, erase the network access code 336 and the network access data 337 stored on the card, thereby preventing the card from authenticating itself again, and preventing the host device from retaining, or regaining, network access. As with other steps previously described, the precise actions of the card 300 at step 930 can be dependent upon the type of security implemented to protect the network 40. Thus, if the network 40 is protected by a variable password that is provided by the trusted computing device 10 to the card 300, then the erasure of the network access code 336 and the network access data 337 can act to prevent the host device from retaining, or regaining, network access as indicated. However, if the network 40 is only protected by a network control access list, then the mere erasure of the network access code 336 and the network access data 337 may not be sufficient, such as, for example, if the trusted computing device 10 does not continually recheck the devices already granted access through the network access control list. In such a case, step 930 can comprise communications between the card 300 and the trusted computing device 10 specifically requesting the revocation of any network access rights granted to the card-provisionable device 200 hosting the card 300.

As can be seen from the above descriptions, card-based provisioning mechanisms can provide network security, the provisioning of devices, and the enforcing of network security by removing undesirable devices. In view of the many possible variations of the subject matter described herein, we claim as our invention all such embodiments as may come within the scope of the following claims and equivalents thereto.

We claim:

1. One or more computer-readable media comprising computer-executable instructions for securing a network and for facilitating the provisioning of a card-provisionable device, the computer-executable instructions directed to steps comprising:
storing, on a card, network access code for utilizing, by the card, networking capabilities of the card-provisionable device to which the card will be communicationally coupled;
storing, on the card, network access data for gaining, for the card while communicationally coupled to the card-provisionable device, access to the secured network sufficient to authenticate the card;
storing, on the card, provisioning data for further provisioning the card-provisionable device;
authenticating the card based on communications received from the card while the card is communicationally coupled to the card-provisionable device; and
providing for the card-provisionable device to be granted access to the secured network.

2. The computer-readable media of claim 1, wherein the computer-executable instructions directed to providing for the card-provisionable device to be granted access to the secured network comprise computer-executable instructions for communicating network access information to the card, for provision, by the card, to the card-provisionable device while the card is communicationally coupled to the card-provisionable device.

3. The computer-readable media of claim 1, wherein the computer-executable instructions directed to providing for the card-provisionable device to be granted access to the secured network comprise computer-executable instructions for adding an identifier of the card-provisionable device to a network access control list for the network.

4. The computer-readable media of claim 1 comprising further computer-executable instructions for storing, on the card, provisioning code, executing on the card to further provision, with reference to the provisioning data, the card-provisionable device to which the card will be communicationally coupled.

5. The computer-readable media of claim 4 comprising further computer-executable instructions for providing provisioning options to a user for selection, the provisioning options selected by the user informing the provisioning data and the provisioning code.

6. The computer-readable media of claim 1 comprising further computer-executable instructions for revoking the access to the secured network that was provided for the card-provisionable device.

7. The computer-readable media of claim 6, wherein the computer-executable instructions for revoking the access comprise computer-executable instructions for removing an identifier of the card-provisionable device from a network access control list for the network.

8. The computer-readable media of claim 6, wherein the revoking the access is in response to an event, detected by a monitoring of the card-provisionable device, the event having been predetermined to trigger the revoking the access.

9. One or more computer-readable media communicationally coupled to a card-provisionable device, the computer-readable media comprising computer-executable instructions for securing a network and for provisioning the card-provisionable device, the computer-executable instructions directed to steps comprising:
provisioning the card-provisionable device in accordance with provisioning data previously stored on the computer-readable media by the trusted computing device;
requesting access to networking capabilities of the card-provisionable device;
accessing the secured network sufficiently to communicate, for authentication purposes, with a trusted computing device to which the computer-readable media were previously communicationally coupled; and
authenticating the computer-readable media with reference to network access data previously stored on the computer-readable media by the trusted computing device.

10. The computer-readable media of claim 9 comprising further computer-executable instructions directed to receiving network access information from the trusted computing device if the authenticating was successful; and providing the network access information to the card-provisionable device.

11. The computer-readable media of claim 9, wherein the computer-executable instructions for provisioning the card-provisionable device are dynamically generated by a trusted computing device in accordance with user input, the user input comprising an identification of the card-provisionable device.

12. The computer-readable media of claim 9 comprising further computer-executable instructions for deleting network access code and network access data from the computer-readable media.

13. The computer-readable media of claim 12 comprising further computer-executable instructions for monitoring the card-provisionable device, wherein the deleting is in response to an event, detected by the monitoring, having been predetermined to trigger the deleting.

14. A method of securing a network with at least one network access card comprising the steps of:
communicationally coupling the network access card to a trusted computing device to enable storage, on the network access card, of a network access code and a network access data for gaining network access and to enable storage of provisioning data for further provisioning a card-provisionable device to which the network access card will be communicationally coupled;
communicationally coupling the network access card to the card-provisionable device to enable the network access card to utilize the network access code, the network access data and networking capabilities of the card-provisionable device to authenticate itself to the trusted computing device and to enable the network access card to utilize the provisioning data to further provision the card-provisionable device; and
providing for the card-provisionable device to be granted access to the secured network if the network access card authenticated itself to the trusted computing device.

15. The method of claim 14, wherein the providing for the card-provisionable device to be granted access to the secured network comprises communicating network access information from the trusted computing device to the card-provisionable device via the network access card.

16. The method of claim 14, wherein the communicationally coupling the network access card to the trusted computing device further enables storage, on the network access card, of provisioning code that executes on the network access card and enables the network access card to provision the card-provisionable device with reference to the provisioning data.

17. The method of claim 16 further comprising the steps of: setting aspects of the card-provisionable device on the trusted computing device, the set aspects informing the provisioning data and the provisioning code.

18. The method of claim 14 further comprising the steps of: revoking the access to the secured network that was provided for the card-provisionable device.

19. The method of claim 18, wherein the revoking the access is in response to an event, detected by a monitoring of the card-provisionable device, the event having been predetermined to trigger the revoking the access.

20. The method of claim 18, wherein the revoking the access is based on the particular network access card.
